(19) United States
(12) Patent Application Publication
(10) Pub. No.: US 2022/0026081 A1
(43) Pub. Date: Jan. 27, 2022

(54) AN APPARATUS FOR REMOVING WATER FROM A FLUID

(71) Applicant: INTEX HOLDINGS PTY LTD, Payneham (AU)

(72) Inventor: Roger DAVIES, Payneham (AU)

(73) Assignee: INTEX HOLDINGS PTY LTD, Payneham (AU)

(21) Appl. No.: 17/311,147

(22) PCT Filed: Oct. 9, 2019
(86) PCT No.: PCT/AU2019/051088

§ 371 Date: Jun. 4, 2021

(51) Int. Cl. F24F 3/14; B01D 53/26; B01D 53/14

(52) U.S. Cl. CPC F24F 3/1417; B01D 53/263; B01D 2252/60; F24F 2003/1464; B01D 2252/103; B01D 53/1425

(57) ABSTRACT

An apparatus to evaporate water from a tank including a plurality of rotating thin discs partially extending into a tank containing the water and causing it to adhere to the discs. Air is caused to flow through the discs causing the water adhered to the discs to evaporate and when the discs rotate back into the tank cool the water. The apparatus can also remove water from a desiccant solution whereby when air is caused to flow through the discs above the solution it causes the water in the desiccant solution to evaporate reducing the water content of the solution.

### FIELD OF THE INVENTION

The present invention not only relates to an apparatus to remove moisture from a liquid desiccant solution that has adsorbed water.

### BACKGROUND TO THE INVENTION

Dehumidification systems are known that remove moisture from a primary stream of air using a desiccant material. The desiccant material adsorbs water at or above ambient temperatures. The material is then subsequently heated to remove the adsorbed water and can then be used once again to remove moisture from a stream of air.

A known property of various metallic salts is termed deliquescence; whereby water vapour from the air is adsorbed by the salt until the salt is entirely dissolved in a liquid solution of water and the salt. Calcium chloride is such a salt. The use of calcium chloride as a desiccant material is known and its potential use in air treatment systems, particularly use as a desiccant in sorption-based air conditioning equipment.

Prior art describes the use of solid or granular calcium chloride in several devices that have the property of removing water from the air.

One difficulty of calcium chloride is that the adsorption process continues until the solid or granular salt dissolves in the adsorbed water and therefore the resulting liquid solution must be contained in an envelope that is permeable to water vapour but impermeable to the liquid solution that forms on contact between anhydrous calcium chloride and moist air.

The prior art generally relates to use in adsorption chillers, or as a means to improve the effectiveness of direct or indirect contact evaporative cooling. A mass transfer device allows the desiccant to adsorb moisture from an air stream, and the desiccant material is heated directly by solar radiation to remove the adsorbed moisture so it can be used again.

The present invention utilises calcium chloride in its liquid state to absorb water vapour from the air, at or near ambient temperature, avoiding the requirement to cool air to below 12 C to remove some water vapour from the air stream. Solutions of calcium chloride are hydroscopic even in relatively dilute concentrations, adsorbing double its weight in water at typical room temperature and humidity.

One object of this invention is to provide an apparatus that removes water from a desiccant material such as calcium chloride subject to an air flow. A heat exchanger ensures that the desiccant solution is at a temperature to aid this process.

A further object of this invention is to provide an apparatus whereby water is adsorbed from an air flow using a desiccant solution that can afterwards be extracted from the solution for other uses.

A yet further object of the present invention is to cool water in a tank by evaporating water using an air flow through rotating discs that lift the water from the tank.

### SUMMARY OF THE INVENTION

In one aspect of the invention there is proposed an apparatus to evaporate water from a tank including a plurality of rotating thin discs partially extending into a tank containing the water and causing it to adhere to the discs, whereby air is caused to flow through the discs causing the water adhered to the discs to evaporate and when the discs rotate back into the tank cool the water.

In a further aspect there is proposed an apparatus to remove water from a desiccant solution including a plurality of rotating thin discs partially extending into a tank containing the desiccant solution and causing it to adhere to the discs, whereby air is caused to flow through the discs above the solution causing the water in the desiccant solution to evaporate reducing the water content of the solution.

Preferably the discs spin into the direction of airflow.

Preferably the discs spin between 10-100 rpm.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1 is a schematic front view of the apparatus embodying the invention;

FIG. 2 a side view of the operation of the apparatus; and

FIG. 3 is a perspective view of the operation of the apparatus.

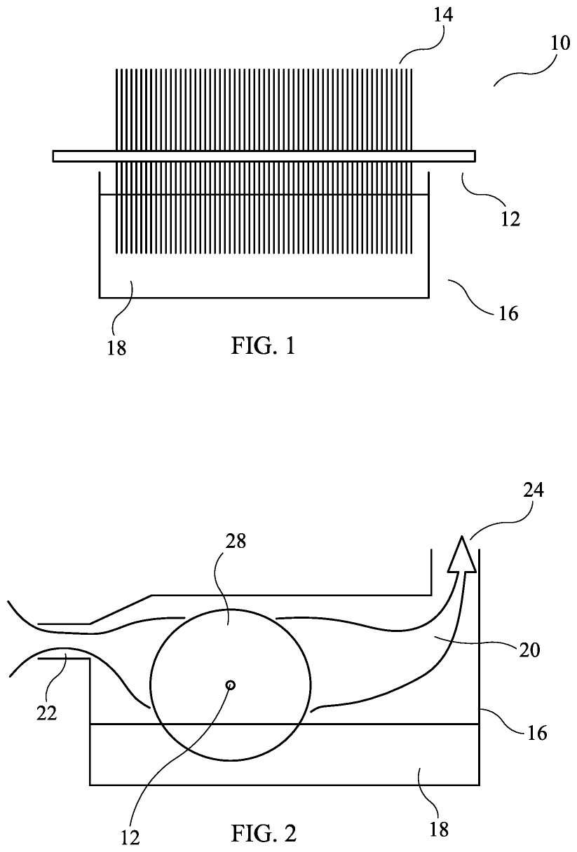

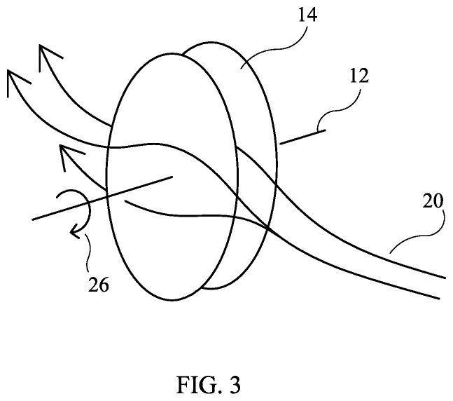

### DETAILED DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

The Figures illustrate conceptually the apparatus embodying the present invention that is directed to removing water from calcium chloride although it may relate to other water absorbing salts. The apparatus 10 includes a shaft on which are mounted a plurality of thin discs 14, generally less than 1 mm in thickness and generally made of a metallic material. The discs are separated by a few millimetres and spacers (not shown) may be used to keep them fixed in position. They are partially located within a tank 16 that includes a calcium chloride solution 18. Air 20 is caused to flow into the tank through inlet 22 and after passing between the discs 14 out through outlet 24. The discs spin into the direction 26 of the air flow. The speed of rotation may be typically between 10 and 100 rpm, but it also may vary from 1-200 rpm and may be variable rather than constant depending on the rate of water loss. Obviously the spinning is caused by a motor or other means (not shown). The number of discs may vary according to the size of the tank and the whole system for removing moisture in air using calcium chloride.

Of course, the discs do not have to be made from a metallic material and may in fact be made of other suitable material such as plastic. It simply needs to be mechanically stable.

As the discs spin through the solution by virtue of surface tension some of the calcium chloride adheres to the discs in a very thin coating. The air passing through the discs then acts to evaporate some of the water in the solution. The calcium chloride is then returned to the tank and the process repeated until a desired amount of water has evaporated from the solution.

A heat exchanger (not shown) can be provided to ensure that the calcium chloride solution is at a temperature to ensure that water can be adsorbed from the air flow.

There are many ways to test how much water has evaporated including measuring the level of the tank, measuring the humidity of the air coming into and out of the tank or measuring the pH concentration of the solution to name a few.

Once it has been determined that sufficient water has been removed from the solution it may be pumped back to the system whereby water is removed from air (not shown).

The discs act to increase the surface area of the solution that is in intimate contact with the air, without having to pump the solution into a wetted membrane or droplet “water tower” which are the conventional technologies. The discs take advantage of the surface tension to lift water out of the body of liquid, whereas surface tension means work must usually be done to separate the water into droplets, for example.

The disc is heated by being in contact with the body of the solution, and delivers sensible thermal energy to the thin layer of solution adhering to the disc surface throughout the time it is in contact with the air, hence preventing the solution from quickly cooling to ambient (which would result in evaporation of water from the solution to cease) maximum drying of solution to be achieved during each pass of the disc through the air stream. Any liquid not evaporated returns to the solution as slightly concentrated solution, on the descending disc.

However, the disc temperature may not be an essential feature since it may not have a meaningful impact on the system function across the range of reasonable operating conditions.

Almost all the work expended to lift the liquid film from the water is returned on the downward journey, saving energy on pumping costs.

The rotating discs have a weak viscous pumping action resulting in slow movement of solution around the tank ensuring uniform mixing of the solution during the evaporating (regeneration) phase. The pumping action also ensures admixing of the air to optimise exchange of water particles into or out of solution—this means there are minimal pumping losses that are otherwise expended to move air across a wetted pad to achieve transfer of water into the air during operation of a conventional evaporator. Similarly, large volumes of air are smoothly acted on with minimal pumping energy cost, during extraction of water vapour from the air during a desiccation (drying) cycle.

The reader will now appreciate the present invention which provides an alternative way to remove water from a calcium chloride solution that has been used to dry air in the first place.

### LIST OF COMPONENTS

The drawings include the following integers.
10 apparatus
12 shaft
14 discs
16 tank
18 calcium chloride solution
20 air flow
22 inlet
24 outlet
26 direction
28 coating

Further advantages and improvements may very well be made to the present invention without deviating from its scope. Although the invention has been shown and described in what is conceived to be the most practical and preferred embodiment, it is recognized that departures may be made therefrom within the scope of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

For example, the above apparatus may be used to cool water by evaporating water from the discs, causing the discs to cool and when the discs spin back into the tank cool the water which can then be used to cool another location by pumping that cooled water to it.

In the present specification and claims (if any), the word “comprising” and its derivatives including “comprises” and “comprise” include each of the stated integers but does not exclude the inclusion of one or more further integers.

1. An apparatus to evaporate water from a tank including a plurality of rotating thin discs partially extending into a tank containing the water and causing it to adhere to the discs, whereby air is caused to flow through the discs causing the water adhered to the discs to evaporate and when the discs rotate back into the tank cool the water.

2. An apparatus to remove water from a desiccant solution including a plurality of rotating thin discs partially extending into a tank containing the desiccant solution and causing it to adhere to the discs, whereby air is caused to flow through the discs above the solution causing the water in the desiccant solution to evaporate reducing the water content of the solution.

3. The apparatus as in claim 2 where the discs spin into the direction of airflow.

4. The apparatus as in claim 1, wherein the discs spin between 10-100 rpm.

5. The apparatus as in claim 2, wherein the discs spin between 10-100 rpm.
